(19) United States
(12) Patent Application Publication
(10) Pub. No.: US 2023/0082678 A1
(43) Pub. Date: Mar. 16, 2023

(54) MAGNIFYING APPARATUS FOR ELECTRONIC DEVICE VIEWSCREEN

(71) Applicant: Elaine Berryman, Greenacres, FL (US)

(72) Inventor: Elaine Berryman, Greenacres, FL (US)

(21) Appl. No.: 17/931,127

(22) Filed: Sep. 11, 2022

Related U.S. Application Data
(60) Provisional application No. 63/243,123, filed on Sep. 11, 2021.
(60) Provisional application No. 63/363,109, filed on Apr. 16, 2022.

(51) Int. Cl. H04M 1/02

(52) U.S. Cl. CPC H04M 1/027

(57) ABSTRACT

A magnifying device includes a frame substantially surrounding the viewscreen of an electronic device. A magnifying lens housed in the frame extends over the viewscreen. The frame allows the distance between the viewscreen and the magnifying lens to be adjusted by an operator. The magnifying device may include two or more additional magnifying lenses wholly or partially coextensive over the viewscreen of the cell phone, and may be adjusted to it just the magnification of the viewscreen. The magnifying device may also include adjustable legs extending between the frame and a base around the periphery of the viewscreen.

### CROSS-REFERENCE TO RELATED APPLICATIONS

This application claims priority to U.S. Provisional Application Ser. No. 63/243,123 filed on Sep. 11, 2021 and U.S. Provisional Application Ser. No. 63/363,109 filed on Apr. 16, 2022.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention:

The present invention relates to a cell phone cover providing magnification of the phone's screen. More particularly, the invention relates to devices for providing personal prescription magnification and/or adjustable magnification of a cell phone screen or other surface.

### Description of the Related Art:

Electronic devices such as, but not limited to smartphones, tablets and laptops are designed for compactness so that they may be stored in a pocket, purse or backpack. The small size of most handheld electronic devices increases the portability and convenience of the devices, but necessitates the use of small screen displays, and usually very small fonts and images. People with poor vision cannot clearly see text and objects on their electronic devices' screens without physically wearing prescription glasses, contact lenses, or reading glasses.

Persons requiring prescription, bifocal or progressive lenses, contact lenses or even common reading glasses for their near sightedness and/or other visual handicaps must use these devices to clearly read these digital viewscreens. As a result, the visually impaired find controlling and using electronic devices difficult, especially when using one hand to execute functions on their devices. It is also inconvenient for a person to don reading glasses every time he or she operates a cell phone.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide devices for modifying a cell phone viewscreen to accommodate persons have visual impairments.

BRIEF SUMMARY OF THE INVENTION

Disclosed is magnifying apparatus for use with viewscreens. The magnifying device for a viewscreen comprises a base extending at least partially along a periphery of a viewscreen, a frame housing at least one magnifying lens, and two or more legs extending from the base to the frame. The magnifying device translates between a collapsed configuration in which the legs are retracted such that the frame lies flush against the base, and an extended configuration in which the adjustable legs are extended such that the frame and at least one magnifying lens are raised a distance above the viewscreen.

In once embodiment, the magnifying device for a viewscreen of claim 1 wherein the magnifying lens is coextensive with the periphery of the viewscreen. The magnifying lens may partially cover the viewscreen.

In another embodiment, the distance between the magnifying lens and the viewscreen when the device is in the open configuration may be adjusted. The magnifying device may include adjustable legs rotatably attached to the base and slidingly attached to the opposing lateral sides of the frame. The distance between the magnifying lens and the viewscreen in the extended configuration is adjusted by limiting the extent to which the adjustable legs are capable of sliding along the lateral sides of the frame. The magnifying device may also include a cover extending over a back side of a device containing the viewscreen.

In one embodiment, one or more magnifying lens are selected from a group consisting of a magnifying lens, a Fresnel lens, a laminated Fresnel lens, and a Fresnel lens modified to provide wavelength independent magnification.

It is therefore an object of the present invention to provide a means for modifying the appearance of a cell phone viewscreen to conform to a desired magnification, such as and including a prescription magnification for an operator of the cell phone.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front plan view of a magnifying device for a viewscreen in accordance with the principles of the invention;

FIG. 2 is a side view of a magnifying device for a viewscreen in accordance with the principles of the invention;

FIG. 3 is a perspective view of a magnifying device for a viewscreen in accordance with the principles of the invention;

FIG. 4 is a side view of an alternative embodiment of a magnifying device for a viewscreen in accordance with principles of the invention;

FIG. 5 is another side view of an alternative embodiment of a magnifying device for a viewscreen in accordance with principles of the invention;

FIG. 6 is a side view of another alternative embodiment of a magnifying device for a viewscreen in accordance with the principles of the invention;

FIG. 7 is another side view of another alternative embodiment of a magnifying device for a viewscreen in accordance with principles of the invention;

FIG. 8 is another side view of another alternative embodiment of a magnifying device for a viewscreen in accordance with principles of the invention;

FIG. 9 is a side view of another alternative embodiment of a magnifying device for a viewscreen in accordance with principles of the invention;

FIG. 10 is a perspective view of another alternative embodiment of a magnifying device for a viewscreen in accordance with the principles of the invention;

FIG. 11 is a perspective view of another alternative embodiment of a magnifying device for a viewscreen in use as a cell phone stand in accordance with the principles of the invention;

FIG. 12 is a top plan view of another alternative embodiment of a magnifying device for a viewscreen in a collapsed configuration in accordance with the principles of the invention;

FIG. 13 is a perspective view of another alternative embodiment of a magnifying device for a viewscreen in an extended configuration in accordance with the principles of the invention;

FIG. 14 is a cross-sectional view of an adjustable leg for another alternative embodiment of a magnifying device for a viewscreen in an extended configuration in accordance with the principles of the invention;

FIG. 15 is another cross-sectional view of an adjustable leg for another alternative embodiment of a magnifying device for a viewscreen in an extended configuration in accordance with the principles of the invention;

FIG. 16 is a top plan view of another alternative embodiment of a magnifying device for a viewscreen in accordance with the principles of the invention;

FIG. 17 is a side elevation view of another alternative embodiment of a magnifying device in an active configuration for a viewscreen in accordance with the principles of the invention;

FIG. 18 is a side elevation view of another alternative embodiment of a magnifying device in an inactive configuration for a viewscreen in accordance with the principles of the invention;

FIG. 19 is a side elevation view of another alternative embodiment of a magnifying device in an active configuration in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. The use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Disclosed are apparatuses and methods magnifying a digital display viewscreen to accommodate persons having visual impairments. In accordance with the principles of the invention, devices include one or more magnifying lenses held in place over a digital display viewscreen. Throughout this specification, devices in accordance with the principles of the invention are described in relation to their use with a cellular telephone. However, those skilled in the art will appreciate that the devices disclosed herein may also be used with a variety of other display types, such as laptop screens, monitors, televisions and the like.

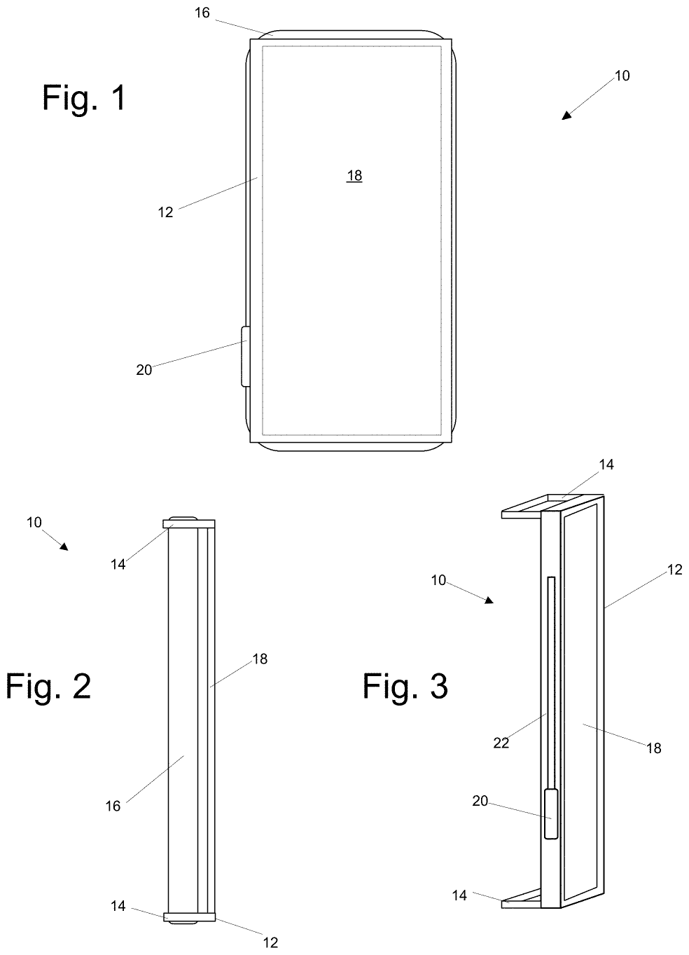

FIGS. 1-3 show a magnifying device 10 in accordance with principles of the invention. In this embodiment, the device 10 is a cell phone cover and includes a frame 12 supported by two U-shaped brackets 14 that wraparound a cell phone 16. The frame 12 supports a magnifying lens 18 that substantially covers the viewscreen of the cell phone 16. The frame 12 includes a button 20 that adjusts the distance between the magnifying lens 18 and the cell phone 16 as it is slid along track 22. By adjusting the distance of the magnifying lens 18 to the cell phone 16, an operator may adjust the magnification of the cell phone's viewscreen. The magnifying lens 18 may be any of a variety of suitable magnification lens types. For example, the magnifying lens 18 may utilize a Fresnel lens, a modified Fresnel lens having two or more laminated layers or other modifications such that the magnification is wavelength independent. The frame 12 is secured to the cell phone 16 only by means of the brackets 14, and therefore does not completely cover the cell phone 16. Optionally, the lens may be configured to provide a specific, prescription level of magnification and secured directly to the viewscreen.

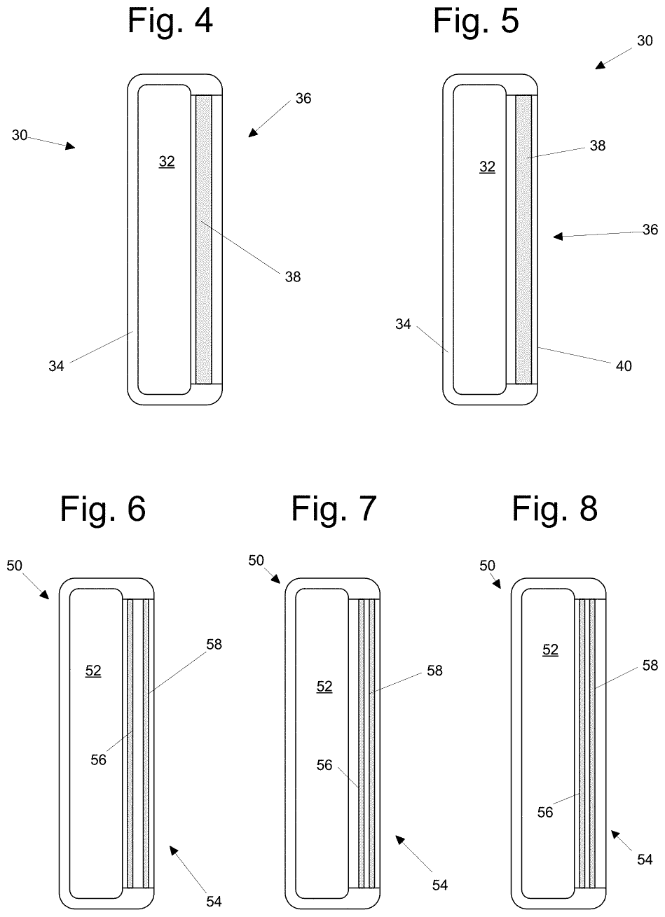

FIGS. 4 and 5 show an alternative embodiment of a magnifying device 30 in accordance with principles of the invention. In this embodiment, a cell phone 32 is completely encased within a cover 34. The front side of the cover 34 has an opening 36 covered by a magnifying lens 38 whose position may be adjusted. FIG. 4 shows the lens 38 close to the cell phone 32. FIG. 5 shows the lens 38 near the outer edge 40 of the cell phone cover 34, further away from the cell phone 32. By adjusting the position of the lens, as with the previous embodiment, a desired level of magnification may be achieved. Also like the previous embodiments, the lens 38 may be any of a variety of lenses.

FIGS. 6-8 show another alternative embodiment of a magnifying device 50 in accordance with principles of the invention. Cell phone cover 50 completely encases a cell phone 52 and also includes an opening 54 on the front of the cover 50. The opening 54 of this embodiment includes an inner lens 56 and an outer lens 58. Lenses 56 and 58 may be moved independently of each other. FIG. 6 shows the two lenses 56 and 58 positioned at almost maximal distances from each other. FIG. 7 shows the lenses 56 and 58 arranged closer to the outside of the opening 54. FIG. 8 shows the lenses 56 and 58 arranged closer to the cell phone 52. One or both of lenses 58 may be a specialized lens such as a Fresnel lens, a laminated lens, a laminated Fresnel lens and the like. By adjusting the lenses 56 and 58, an operator may adjust the magnification of the screen of the cell phone 52.

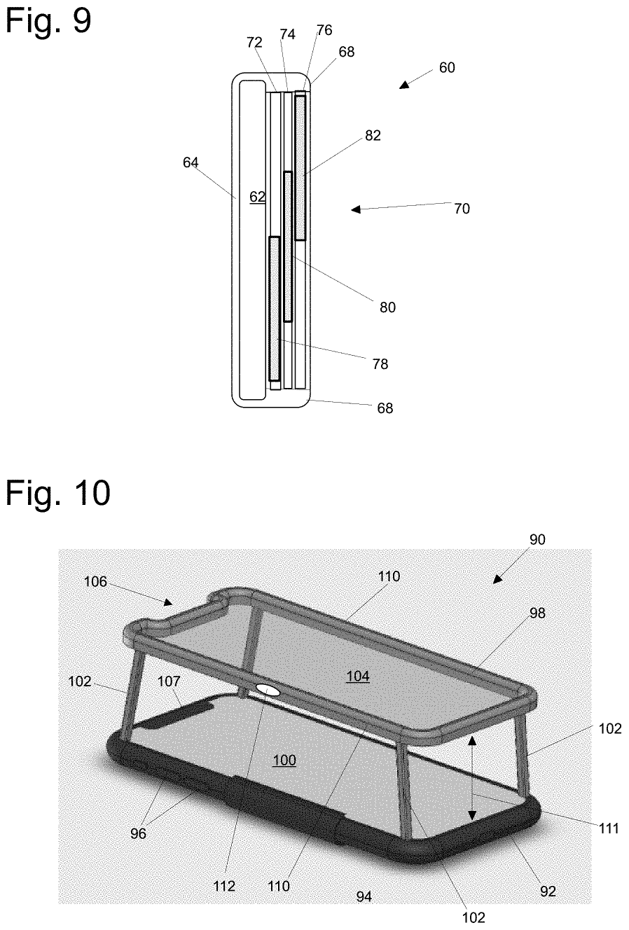

FIG. 9 shows another alternative embodiment of a magnifying device 60 for a viewscreen in accordance with principles of the invention. Magnifying device 60 houses a tablet 62 within an outer casing 64 which defines a frame 68 having an opening 70. Opening 70 has three coextensive independent tracks 72, 74 and 76. Three rectangular magnifying lenses 78, 80 and 82 are slidably engaged with the independent tracks 72, 74 and 76, respectively. Each of the magnifying lenses 78, 80 and 82 are approximately one half the length of the viewscreen of the tablet 62. An operator may slide 12 all three of these sliding lenses over a section of the cell phones view screen he or she wishes to view. This allows the operator to adjust the magnification of the view screen to a suitable setting. It also allows the viewer to magnify different sections of the cell phone screen by different amounts simultaneously. Optionally, one or more of the magnifying lenses may be interchangeable with additional magnifying lenses. Optionally, one or more of the rectangular lenses may be constructed to magnify the screen according to an operator's prescription. The screens may also optionally darken within sunlight or have varying degrees of shading, thereby allowing some or all of the cell phone screen to be brighter than other portions.

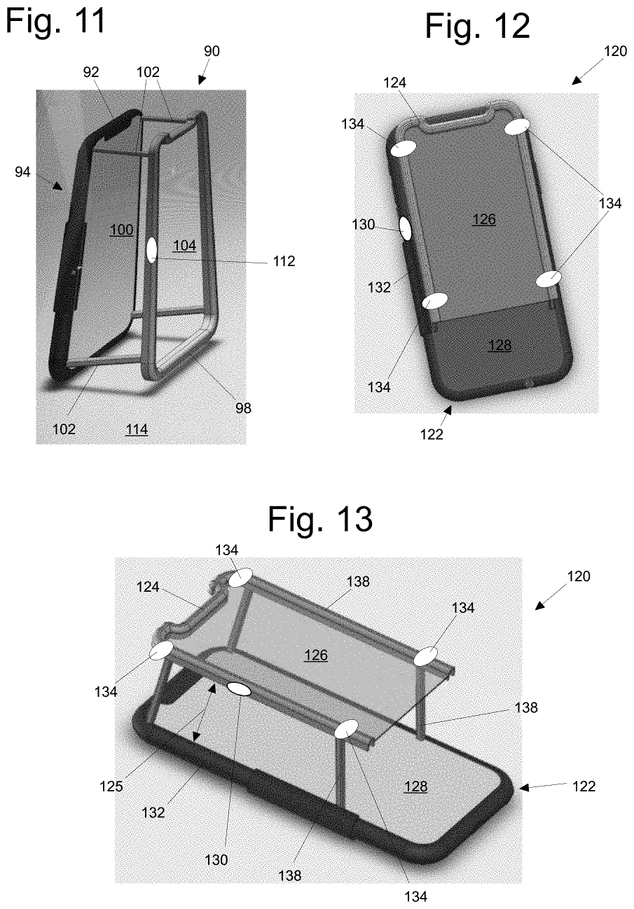

FIGS. 10 and 11 show another alternative embodiment of a magnifying device for a viewscreen 90 in accordance with the principles of the invention. The magnifying device 90 includes a base 92 which extends around the peripheral sides of a viewscreen 100. In this embodiments, the viewscreen 100 extends across one side of a cell phone 94. The base 92 extends along the sides of the cell phone 94 adjacent to the viewscreen 100. The base 92 may optionally include a back cover (not shown) extending over the back side of the cell phone 94 such that the base 92 serves as a cell phone case, and includes openings through which the cell phones buttons, for example volume controllers 96 and on-off buttons, may be accessed through the base 92.

A frame 98 is positioned over the viewscreen 100 of the cell phone 94 and is attached to the base 92 by four legs 102. The frame 98 has a substantially rectangular shape and is substantially coextensive with the base 92. A magnifying lens 104 is housed within and supported by the frame 98. The magnifying lens 104 extends at least partially across the viewscreen 100 and is at least partially coextensive with the viewscreen 100. In this embodiment, the frame 98 includes a rectangular top recess 106 to ensure that the frame 98 and magnifying lens 104 do not extend over the forward facing camera 107 of the cell phone 94.

The legs 102 are rotatably attached to the base 92 at each of the corners. The legs 102 are slidingly attached to the lateral sides 110 frame 98. FIG. 10 shows the magnifying device 90 in the extended configuration in which the magnifying lens 104 is positioned above the viewscreen 100 at a distance 111 determined by the links of the legs. Biasing springs within the lateral sides 110 a frame 98, as explained below, hold the legs 102 in the extended position.

The magnifying device 90 may be converted to a collapsed configuration where the frame 98 lies substantially flush with the base 92 and the magnifying lens 104 lies substantially flush with the viewscreen 100. To collapse the magnifying device 90, the frame 98 is pushed down onto the base 92 until a lock is engaged. When the magnifying device 90 is in the collapsed configuration, the button 112 is depressed which releases the lock. The biasing Springs then slide the tops of the legs 102 along an internal guide and the bottoms of the legs rotate within the base 92, causing the magnifying device 92 pop into the extended configuration.

FIG. 11 shows a magnifying device 90 in casing a cell phone 94 in an extended configuration and sitting upright on a surface 114. In this manner, the extended configuration of the magnifying device 90 provides the added functionality of a cell phone stand. The magnifying device 90 holds the cell phone and a substantially vertical orientation, allowing an operator to easily view the viewscreen 100 under magnification hands-free. While this embodiment shows use of the magnifying device 90 with a cell phone 94, those skilled in the art will appreciate that inappropriately sized magnifying device 90 may be used with a computer tablet or laptop.

FIGS. 12 and 13 show another alternative embodiment of a magnifying device 120 for a cell phone 122 in accordance with the principles of the invention. FIG. 12 shows the magnifying device 120 in the collapsed configuration with the frame 124 flush against the base 132 and the magnifying lens 126 substantially flush against the viewscreen 128. FIG. 13 shows the magnifying device 120 in the extended configuration with the frame 124 and magnifying lens 126 raised a predetermined distance above the base 132 and the viewscreen 128, respectively.

The magnifying device 120 operates similarly to the magnifying device 90 but includes a frame 124 and magnifying lens 126 that only partially cover the viewscreen 128 of the cell phone 122. The lower region of the viewscreen 128, commonly used to display a keyboard, is not covered to allow an operator to access and operate the displayed keyboard. A release button 130 is depressed to disengage the frame 124 from the base 132 of the magnifying device 120. Magnifying device 120 also includes four distance adjusters 134 that may be actuated and slid along the links of the lateral sides 136 of the frame 124. By moving the distance adjusters 134, an operator adjusts the extent to which the adjustable legs 138 slide along the lateral sides 136 of the frame 124. This in turn changes the distance 125 between the viewscreen 128 and the magnifying lens 126 when the magnifying device 120 is in the extended configuration.

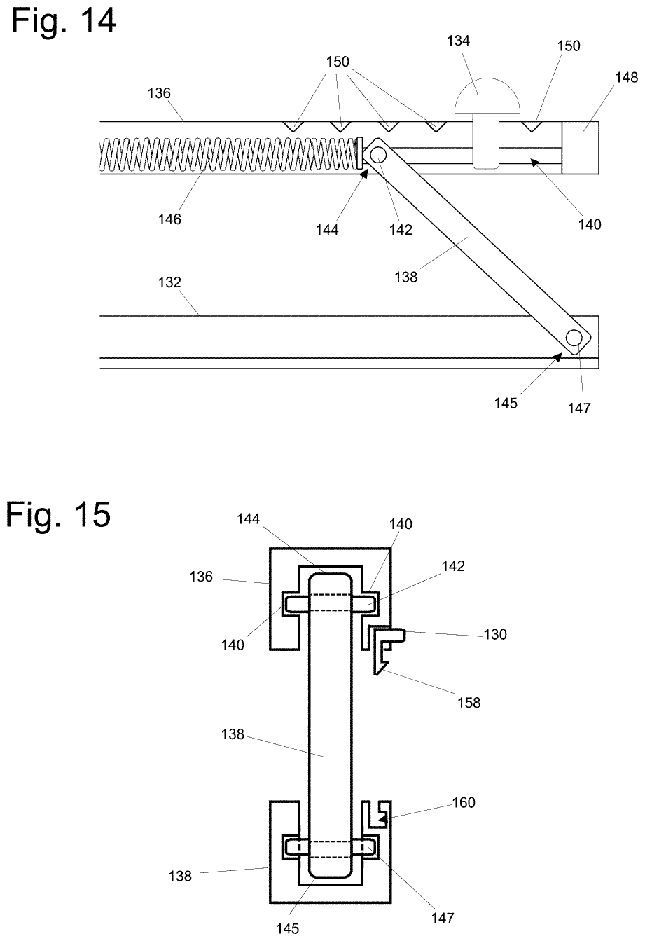

FIGS. 14 and 15 show one of the adjustable legs 138, one of the lateral sides 136 of the frame 124, and the base 132 in more detail. The lateral side 136 of the frame 124 includes internal slots 140 along which the sliding pin 142, attached to the top 144 of the adjustable leg 138, slides. The bottom 145 of the adjustable leg 138 is rotatably affixed to the base 132 by a pivot pin 147.

Referring to FIG. 14, a spring 146 biases the top 144 of the adjustable leg 138 in the direction of the end 148 of the lateral side 136. The distance adjuster 134 engages one of the slots 150 in the lateral side 136. The top 144 of the adjustable leg 138 is stopped by the distance adjuster 134. The distance adjuster 134 may be moved to engage with any of the slots 152 limit the length of the top 144 of the adjustable leg 138 may move down the internal slots 140. This in turn adjusts the distance between the frame 124 and the cell phone 122 when the magnifying device 120 is in an extended configuration.

Referring to FIG. 15, the release button 130 actuates a tab 158 which locks into a recess 160 in the base 132. By depressing the button 130, the lock is released allowing the biasing Springs 146 to cause the adjustable legs 138 to slide toward the ends of the lateral sides 136 of the frame, thereby moving the frame 124 away from the base 132 and pushing the frame 124 away from the base 132. The adjustable legs 102 of magnifying device 90 operate in a similar fashion and FIGS. 14 and 15 should be considered as applying to any configuration having legs that rotate to translate the position of the frame in the extended and collapsed configurations of the magnifying device.

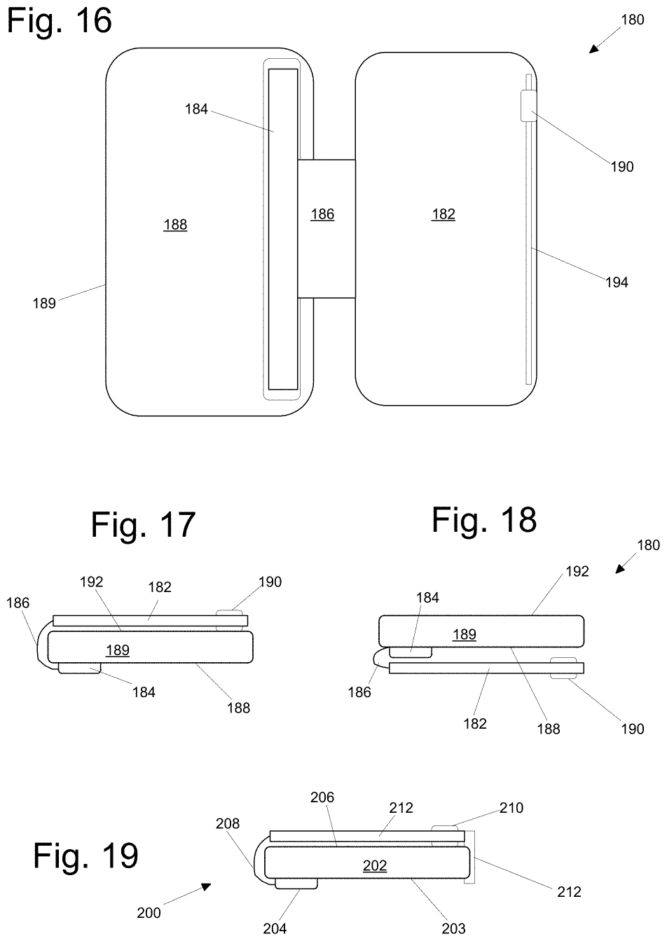

FIGS. 16 to 18 show a magnifying viewing screen cover 180 in accordance with the principles of the invention. The viewing screen cover 180 includes a magnifying lens 182, an anchor 184, and a flexible tether 186, which secures the anchor 16 to the back 188 of a cell phone 189. The magnifying lens 182 includes a slide control 190, which impinges on the cell phone's viewscreen 192 and is conductive to allow an operator to scroll down the page displayed by the cell phone's viewscreen underneath the magnifying lens 182. The slide control 190 slides along track 194.

In FIG. 17, the magnifying lens 182 is in the active position on the front screen of a cell phone 189. The magnifying screen 182 has been placed over the viewscreen 192 of the cell phone 189. When in use, the slide control 190 slides along the track 194. The slide control 190 is used to scroll up and down to assist the visually impaired when viewing or reading text on a cell phone 189. However, as shown, the anchor 184 has not been attached to the back of the cell phone 188.

In FIG. 18, magnifying device 180 has translated from the active position shown in FIG. 17 to an inactive position. To translate from the active position to the inactive position, the magnifying lens 182 is flipped to the back 188 of the cell phone 22. Likewise, to translate the magnifying device 182 from the inactive position to the active position, the magnifying lens 182 is flipped to the front screen the cell phone 189.

FIG. 19 shows another embodiment of a magnifying device 200 in accordance with the principles of the invention. Magnifying device 200 and is affixed to a cell phone 202 by an anchor 204 on the back 203 of the cell phone 202. A magnifying lens 206 is attached to the anchor 204 by a tether 208. The magnifying lens 206 also includes a slide control 210 for scrolling along a page displayed on the viewscreen 212. In this embodiment, the magnifying device 200 includes a clasp 212 for securing the magnifying lens 206 over the viewscreen 212 in the active position. As shown, the clasp 212 would be on the free end of the magnifying screen 16 and would assist in temporarily affixing the magnifying lens 206 to the viewscreen 212. The clasp 212 is shown to be a hook composed of a semi-flexible material, such as a polycarbonate plastic, that has both a width and a length, and that is sized appropriately to have a slight overlap with the edge of a cell phone.

Those skilled in the art will appreciate that the principles of the invention disclosed herein may be utilized in a variety of situations. In addition to cell phones, the invention may also be applied to laptops, tablets, monitors, televisions and a wide variety of other viewing screens. The lenses may also be formed by a magnifying film which may be applied directly to a viewscreen on the cell phone or a plate of transparent plastic or glass extending over the viewscreen. Any desired level of magnification may be provided, but a range of 0.025-5.00 is typical.

Those skilled in the art will appreciate that a variety of other features may be combined with the principles of the invention disclosed here in. For example, the magnifying lens may be antiglare, antireflective, scratch resistant, may include a red or blue light filter. The components of the invention may be formed by glass, plastic, polycarbonates, or other suitable materials.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1.-6. (canceled)

7. A magnifying device for a viewscreen comprising:
a base extending at least partially along a periphery of a viewscreen;
a frame housing at least one magnifying lens; and, two or more legs extending from the base to the frame;
wherein the magnifying device translates between a collapsed configuration in which the two or more legs are retracted such that the frame lies flush against the viewscreen, and an extended configuration in which the two or more legs are extended such that the frame and the at least one magnifying lens are raised a distance above the viewscreen;
and wherein the magnifying device includes a lock that is engaged when the magnifying device is in the collapsed position, and a button that disengages the lock to allow the magnifying device to translate to the extended configuration.

8. The magnifying device for a viewscreen of claim 7 wherein the distance between the at least one magnifying lens and the view screen when the device is in the extended configuration may be adjusted.

9. The magnifying device for a viewscreen of claim 8 wherein each of the two or more legs is rotatably attached to the base and slidingly attached to the opposing lateral sides of the frame, and the distance between the at least one magnifying lens and the viewscreen in the extended configuration is adjusted by limiting the extent to which the two or more legs are capable of sliding along the lateral sides of the frame.

10. The magnifying device for a viewscreen of claim 9 wherein the base further comprises a cover extending over a back side of a device containing the viewscreen.

11. The magnifying device for a viewscreen of claim 10 wherein the magnifying lens is coextensive with the periphery of the viewscreen.

12. The magnifying device for a viewscreen of claim 10 wherein the magnifying lens partially covers the viewscreen.

13. A magnifying device for a viewscreen comprising:
a frame housing at least one magnifying lens; and,
a pair of brackets extending perpendicularly from the periphery of the frame;
wherein the frame and the pair of brackets form a substantially U-shape device.

14. The magnifying device for a viewscreen of claim 13 wherein the magnifying lens is coextensive with the periphery of the viewscreen.

15. The magnifying device for a viewscreen of claim 14 wherein one of the pair of brackets is affixed to the top side of the frame and the other is affixed to the bottom side of the frame.

16. The magnifying device for a viewscreen of claim 15 wherein the pair of brackets are substantially rectanguloid.

17. The magnifying device for a viewscreen of claim 16 wherein the rectanguloid pair of brackets comprise a through opening on their top side coextensive with the width of the viewscreen.

18. The magnifying device for a viewscreen of claim 17 wherein the distance between the magnifying lens and the viewscreen can be adjusted.

19. The magnifying device for a viewscreen of claim 18 wherein the frame houses two or more magnifying lenses, and wherein the magnifying lenses vary in magnification.

20. A magnifying device for a viewscreen comprising:
a frame housing at least one magnifying lens;
an anchor; and,
a flexible tether;
wherein the flexible tether connects a distal side of the anchor to a proximal side of the frame.

21. The magnifying device for a viewscreen of claim 20 wherein the magnifying device translates between an active position in which the frame lies flush with the front of the viewscreen, and an inactive position in which the frame lies flush with a back side of a device containing the viewscreen.

22. The magnifying device for a viewscreen of claim 21 wherein the magnifying lens is coextensive with the periphery of the viewscreen.

23. The magnifying device for a viewscreen of claim 22 wherein the frame comprises a clasp on its distal end.

24. The magnifying device for a viewscreen of claim 23 wherein the frame houses a slide control on its distal edge.

25. The magnifying device for a viewscreen of claim 24 wherein the anchor is permanently affixed to the back side of the device containing the viewscreen.

26. The magnifying device for a viewscreen of claim 25 wherein the anchor is removably affixed to the back side of the device containing the viewscreen.
